(19) United States
(12) Patent Application Publication
(10) Pub. No.: US 2010/0188369 A1
(43) Pub. Date: Jul. 29, 2010

(54) IMAGE DISPLAYING APPARATUS AND IMAGE DISPLAYING METHOD

(75) Inventor: Eiji Aizawa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/692,304

(22) Filed: Jan. 22, 2010

(30) Foreign Application Priority Data
Jan. 26, 2009 (JP) 2009-014412

(51) Int. Cl. G06F 3/048; G06F 3/042; G06F 17/30

(52) U.S. Cl. 345/175; 707/758; 715/764; 707/E17.014

(57) ABSTRACT

An image displaying apparatus according to the present invention is characterized by comprising: a position detection unit which detects a position of an object on a screen of a display unit; an attribute detection unit which detects an attribute of the object; a data search unit which searches for, from a storage unit, data associated with the attribute detected by the attribute detection unit; and a display control unit which displays the data searched by the data search unit, on the basis of the position of the object detected by the position detection unit.

### BACKGROUND OF THE INVENTION

1. Field of the Invention

The present invention relates to an image displaying apparatus, an image displaying method, a computer-readable program for achieving the image displaying method, and a computer-readable storage medium which stores therein the program for achieving the image displaying method. In particular, the present invention relates to a technique which is suitably used to search for desired associated data from among data displayed on a screen of a display.

2. Description of the Related Art

In recent years, according to progress of techniques concerning a flat panel display and a front projector, a small-sized portable display terminal and a large-sized screen display are cooperated with each other. For example, Japanese Patent Application Laid-Open No. 2006-195668 proposes a format in which digital data from plural portable display terminals are seamlessly registered in and displayed on a large-sized screen display. Here, the plural digital data displayed on the display include various data such as moving image data, still image data, document data and the like. As just described, by registering the digital data from the plural portable display terminals as displaying them on the large-sized display screen, it is possible to simultaneously browse the plural data, and it is thus possible to improve browsing efficiency.

### SUMMARY OF THE INVENTION

The present invention has been completed in consideration of the above-described related art, and aims to enable a user of a display to effectively confirm and identify desired data from among various data displayed on the display.

To achieve such an object as described above, an image processing apparatus according to the present invention is characterized by comprising: a position detection unit configured to detect a position of an object on a screen of a display unit; an attribute detection unit configured to detect an attribute of the object; a data search unit configured to search for, from a storage unit, data associated with the attribute detected by the attribute detection unit; and a display control unit configured to display the data searched by the data search unit, on the basis of the position of the object detected by the position detection unit.

According to the present invention, it is possible to display the data associated with the attribute of the object at a predetermined position. Thus, it is possible for the user to effectively confirm the desired data from among the data displayed on the display unit.

Further features of the present invention will become apparent from the following description of exemplary embodiments with reference to the attached drawings.

### BRIEF DESCRIPTION OF THE DRAWINGS

FIG. 1 is a block diagram illustrating an example of the schematic constitution of an image displaying apparatus according to the embodiment of the present invention.

FIG. 2 is a diagram illustrating an example of the outer appearance of the image displaying apparatus which includes an object position detection unit, an object attribute extraction unit and a display unit respectively illustrated in FIG. 1.

FIG. 3 is a flow chart indicating an example of a processing procedure by the image displaying apparatus according to the embodiment of the present invention.

FIG. 4 is a diagram illustrating an example of a display screen in the state that a process in a step S301 of FIG. 3 is performed.

FIG. 5 is a diagram illustrating an example of a screen displayed by a process in a step S307 of FIG. 3.

### DESCRIPTION OF THE EMBODIMENTS

### First Embodiment

Hereinafter, the first embodiment of the present invention will be described with reference to the attached drawings.

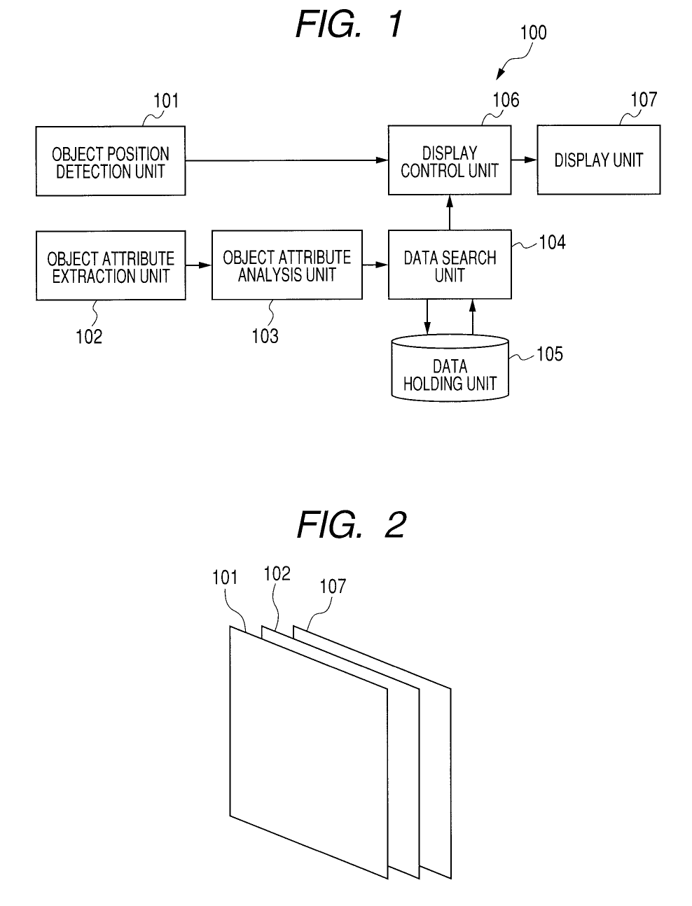

FIG. 1 is a block diagram illustrating an example of the schematic constitution of an image displaying apparatus 100 according to the present embodiment. In FIG. 1, an object position detection unit 101 is used to detect a position of an object (body) which has been physically attached to or put on the surface of display unit 107. Here, it should be noted that the position of the object is also called an object position hereinafter. Incidentally, the position of the object is detected by using a later-described touch panel. It should be noted that the object is, for example, a sticky note or the like on which characters or the like have been written. On the other hand, an object attribute extraction unit 102 is used to extract an attribute (object attribute) from the characters or the like included in the object (body) on the surface of the display unit 107. Incidentally, the object attribute is extracted by using a later-described optical sensor.

An object attribute analysis unit 103 is used to analyze the object attribute extracted by the object attribute extraction unit 102. Here, the object attribute is analyzed by using an OCR (optical character recognition) technique. In the present embodiment, although the OCR technique is used for the object attribute analysis unit 103, an OMR (optical mark recognition) technique or the like may be used if a mark is used as the object attribute. As just described, it should be noted that the object attribute extraction unit 102 and the object attribute analysis unit 103 together function as an attribute detection unit.

A data search unit 104 is used to search data from a later-described data holding unit 105, on the basis of the attribute analyzed by the object attribute analysis unit 103. Here, the data holding unit 105 is the memory which holds or stores therein the data to be displayed on the display unit 107.

A display control unit 106 generates a display image for displaying the data searched by the data search unit 104, and displays the generated display image in the vicinity of the object position detected by the object position detection unit 101. Further, the display unit 107 is used to display the display image generated by the display control unit 106.

FIG. 2 is a diagram illustrating an example of the outer appearance of the image displaying apparatus which includes the object position detection unit 101, the object attribute extraction unit 102 and the display unit 107.

In FIG. 2, the touch panel is used as the object position detection unit 101. More specifically, on the surface of the touch panel, if a current flows at the position which has been pressed, the pressure generation position on the touch panel can be detected. Incidentally, in the present embodiment, although the touch panel is used as the sensor for the object position detection unit 101, the object position may be detected by using an optical sensor, a camera, a scanner or the like.

An optical sensor which is provided for each pixel is used as the object attribute extraction unit 102. More specifically, if reflected light which is obtained by reflecting backlight of the display unit 107 on the object existing on the surface of the display unit 107 is received by the optical sensor, the object attribute on the surface of the display unit can be extracted. In the present embodiment, although the optical sensor is used as the object attribute extraction unit 102, the object attribute may be extracted by using a camera, a scanner or the like. In addition, instead of the reflected light, transmitted light which is transmitted through the object may be received by the optical sensor.

Further, a flat panel display is used as the display unit 107, and the backlight of the display unit 107 emitted for each pixel is irradiated on the surface of the display unit 107. Furthermore, as described above, the reflected light of the backlight is used by the object attribute extraction unit 102 to extract the object attribute. In any case, in the present embodiment, although the flat panel display is used for the display unit 107, a front projector, a CRT (cathode ray tube) or the like may be used for the display unit 107.

As just described, in the present embodiment, the touch panel is used as the object position detection unit 101, the optical sensor is used as the object attribute extraction unit 102, and the flat panel display is used for the display unit 107. Further, these units are laminated thrice as illustrated in FIG. 2. Thus, the position and the attribute of the object (body) which is in contact with the surface of the display unit 107 are respectively detected and extracted.

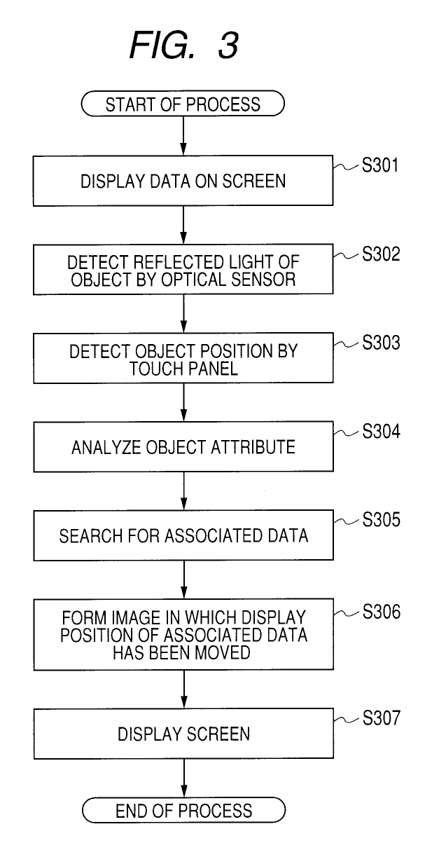

FIG. 3 is a flow chart indicating an example of a processing procedure to be performed by the image displaying apparatus 100 according to the present embodiment.

Initially, in a step S301 illustrated in FIG. 3, the data held in the data holding unit 105 is read by the data search unit 104 in response to an operation by a user, and the read data is displayed on the display screen of the display unit 107 by the display control unit 106.

Next, if an object is attached on the display screen of the display unit 107, the flow advances to a step S302. In this step, the reflected light is detected by the optical sensor acting as the object attribute extraction unit 102, whereby the object attribute is extracted. Then, in a step S303, as described above, the pressure generation position is detected on the touch panel acting as the object position detection unit 101, whereby the object position is detected. Here, it should be noted that it is possible to reverse the order by which the processes in the steps S302 and S303 are performed.

Next, in a step S304, the object attribute extracted in the step S302 is analyzed by the object attribute analysis unit 103. Then, in a step S305, the data which is associated with the object attribute analyzed in the step S304 is searched from the data holding unit 105 by the data search unit 104.

Next, in a step S306, the display image in which the data searched in the step S305 has been moved to the vicinity of the object position detected in the step S303 is generated by the display control unit 106. Then, in a step S307, the display image generated in the step S306 is displayed on the display screen of the display unit 107. After then, the process ends.

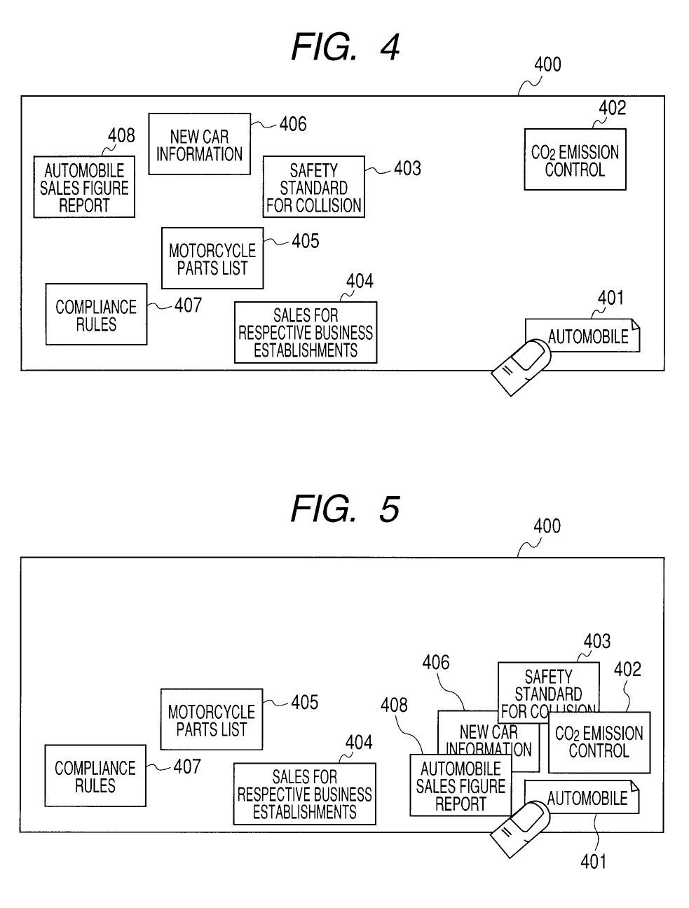

Subsequently, the details of a visual effect which is obtained when an image display system according to the present embodiment is used will be described with reference to FIGS. 4 and 5.

FIG. 4 is the diagram illustrating an example of the display screen in the state that the process in the step S301 of FIG. 3 is performed. More specifically, FIG. 4 illustrates the state that the object is attached to the display unit 107 by the user's operation. Incidentally, for example, the display of the data in the step S301 is performed by displaying a menu screen on the display unit 107 and performing proper operations with use of the touch panel or another operation unit.

In FIG. 4, a screen 400 is displayed on the display unit 107 of the image displaying apparatus illustrated in FIG. 2. Further, an object (sticky note) 401, and data 402, 403, 404, 405, 406, 407 and 408 are displayed on the display unit 107.

The attribute “AUTOMOBILE” has been handwritten on the sticky note 401. FIG. 4 indicates the state immediately before the sticky note 401 is detected. Here, the data 402 is the data associated with car exhaust emission control, the data 403 is the data associated with a safety standard for car collision, the data 404 is the data associated with sales for respective business establishments, the data 405 is the data associated with a price list of motorcycle parts, the data 406 is the data associated with new car information, the data 407 is the data associated with in-company compliance rules, and the data 408 is the data associated with a car sales figure report.

Incidentally, the data 402 to 408 have been stored in the data holding unit 105. Further, it is assumed that the attribute “AUTOMOBILE” has been added respectively to the data 402 associated with the car exhaust emission control, the data 403 associated with the safety standard for car collision, the data 406 is the data associated with the new car information, and the data 408 associated with the car sales figure report.

Here, if the sticky note 401 is attached on the screen 400, the processes in the steps S302 and S303 of FIG. 3 are performed. More specifically, the backlight of the image displaying apparatus reflected on the sticky note 401 is detected by the optical sensor acting as the object attribute extraction unit 102, whereby the attribute is extracted. Further, the contact position at which the pressure is detected by the touch panel acting as the object position detection unit 101 is extracted.

Next, the attribute extracted by using the optical sensor in the process of the step S304 is analyzed by using the OCR technique in the object attribute analysis unit 103, whereby the attribute “AUTOMOBILE” is detected. Subsequently, the associated data are searched from the data holding unit 105 by the data search unit 104, by using as the search key the attribute “AUTOMOBILE” detected in the process of the step S305. In the example illustrated in FIG. 4, the data 402 associated with the car exhaust emission control, the data 403 associated with the safety standard for car collision, the data 406 associated with the new car information, and the data 408 associated with the car sales figure report are searched.

Next, in the step S306, the display image in which the data searched in the step S305 has been moved to the vicinity of the object position detected in the step S303 is generated by the display control unit 106. Then, in the step S307, the display image generated in the step S306 is displayed on the display screen of the display unit 107.

FIG. 5 is the diagram illustrating an example of the screen displayed by the process in the step S307 of FIG. 3. As illustrated in FIG. 5, the data 402 associated with the car exhaust emission control, the data 403 associated with the safety standard for car collision, the data 406 associated with the new car information, and the data 408 associated with the car sales figure report are displayed in the vicinity of the sticky note 401. As described above, it should be noted that all of these data displayed are associated with the attribute “AUTOMOBILE”.

Incidentally, in the present embodiment, it is controlled by the display control unit 106 to display the data so that the data associated with the object attribute are displayed in the vicinity of the object. However, if it is possible for the user of the display to effectively confirm desired data from among the data displayed on the display unit, how to control display is not limited to that for displaying the data associated with the object attribute in the vicinity of the object. For example, it is possible to control to display the data so that the data associated with the object attribute are emphasized.

As just described, according to the present embodiment, the position and the attribute of the object attached on the display screen are detected, and then the associated attribute data are displayed in the vicinity of the relevant object. Consequently, it is possible for the user to effectively confirm the desired data from among the data displayed on the display.

Incidentally, in the present embodiment, the image displaying apparatus as illustrated in FIG. 2 are used by way of example. However, the present embodiment is also applicable to a case where, under the control of the display control unit 106, the display screen is projected by using a movie screen or the like instead of the display unit 107. In this case, if a function for performing camera photographing is provided to each of the object position detection unit 101 and the object attribute extraction unit 102, then it is possible to detect the position and the attribute of the object by photographing the screen which is projected on the movie screen or the like.

### OTHER EMBODIMENTS

It should be noted that the respective units constituting the image displaying apparatus and the respective steps included in the image displaying method, according to the above-described embodiment of the present invention, can be achieved if programs stored in a RAM, a ROM and the like of a computer operate. In this connection, the programs and a computer-readable storage medium storing therein the programs are included in the present invention.

Further, the present invention can be carried out as, for example, a system, an apparatus, a method, a program, a storage medium or the like. More specifically, the present invention may be applied to a system consisting of plural devices, or to an apparatus comprising a single device.

Incidentally, the present invention also includes a case where a software program (in the above-described embodiment, the program corresponding to the flow chart illustrated in FIG. 3) for achieving the functions of the above-described embodiment is directly or remotely supplied to the system or the apparatus. Further, the present invention includes a case where a computer in the system or the apparatus reads and executes the supplied program and thus the above-described functions are achieved.

Therefore, program codes themselves installed in the computer to achieve the functional processes of the present invention by the computer achieve the present invention. That is, the computer program itself to achieve the functional processes of the present invention is included in the present invention.

In this case, because the form of the program is no object if it has an actual function as the program, an object code, a program executed by an interpreter, script data supplied to an OS, and the like may be included as the program.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-014412, filed Jan. 26, 2009, which is hereby incorporated by reference herein in its entirety.

What is claimed is:

1. An image displaying apparatus comprising:
a position detection unit configured to detect a position of an object on a screen of a display unit;
an attribute detection unit configured to detect an attribute of the object;
a data search unit configured to search for, from a storage unit, data associated with the attribute detected by the attribute detection unit; and
a display control unit configured to display the data searched by the data search unit, on the basis of the position of the object detected by the position detection unit.

2. The image displaying apparatus according to claim 1, wherein the display control unit displays the data searched by the data search unit, in the vicinity of the position of the object detected by the position detection unit.

3. The image displaying apparatus according to claim 1, wherein the position detection unit detects the position of the object by using a sensor which detects a contact position on a surface of the display unit.

4. The image displaying apparatus according to claim 1, wherein the attribute detection unit detects the attribute of the object by using an optical sensor which detects reflected light or transmitted light of backlight of the display unit.

5. The image displaying apparatus according to claim 1, wherein the position detection unit detects the position of the object by photographing the object on the screen of the display unit, and
the attribute detection unit detects the attribute by photographing the object on the screen of the display unit.

6. An image displaying method comprising:
detecting a position of an object on a screen of a display unit;
detecting an attribute of the object;
searching for, from a storage unit, data associated with the detected attribute; and
displaying the searched data on the basis of the detected position of the object.

7. The image displaying method according to claim 6, wherein, in the displaying, the searched data is displayed in the vicinity of the detected position of the object.

8. The image displaying method according to claim 6, wherein, in the detection of the position, the position of the object is detected by using a sensor which detects a contact position on a surface of the display unit.

9. The image displaying method according to claim 6, wherein, in the detection of the attribute, the attribute of the object is detected by using an optical sensor which detects reflected light or transmitted light of backlight of the display unit.

10. The image displaying method according to claim 6, wherein in the detection of the position, the position of the object is detected by photographing the object on the screen of the display unit, and
in the detection of the attribute, the attribute of the object is detected by photographing the object on the screen of the display unit.

11. A computer-executable program which is used to cause a computer to execute:
detecting a position of an object on a screen of a display unit;
detecting an attribute of the object;
searching for, from a storage unit, data associated with the detected attribute; and
displaying the searched data on the basis of the detected position of the object.

12. A computer-readable storage medium which stores therein a program as described in claim 11.
